(19) United States
(12) Patent Application Publication
(10) Pub. No.: US 2020/0114542 A1
(43) Pub. Date: Apr. 16, 2020

(54) Automatic processing irrigation truck for concrete pier for bridge pier

(71) Applicant: Huangen Zhang, Tianjin City (CN)

(72) Inventor: Huangen Zhang, Tianjin City (CN)

(21) Appl. No.: 16/714,796

(22) Filed: Dec. 16, 2019

(30) Foreign Application Priority Data
Sep. 6, 2019 (CN) 2019108433795

(51) Int. Cl. B28C 5/42; B60P 3/16; F16H 19/04; F16H 1/22; E02D 15/02; F15B 13/00

(52) U.S. Cl. CPC B28C 5/4289; B60P 3/16; F16H 19/04; B28C 5/4286; E02D 15/02; F15B 13/00; B28C 5/4258; F16H 1/22

(57) ABSTRACT

The invention discloses an automatic processing irrigation truck for concrete pier for bridge pier, and includes a body plate, a bottom plate is fixed on the end surface of the body plate, and a storage block is fixed on the right side of the end surface of the bottom plate. A processing mechanism is provided in the storage block, and the processing mechanism includes a stirring cavity with an opening facing upward. The agitating chamber is used for containing concrete. The agitating chamber is provided with a rotatable drive shaft. Ten ten agitating rods are evenly fixed on the drive shaft. The device can be used for bridge pier during transportation. The processing of concrete, by means of stirring and spiral circulation, can not only make the processing fully, but also prevent the subsequent layering of the concrete, ensure the quality of the concrete, and use spiral transportation when needed.

### CROSS-REFERENCES TO RELATED APPLICATIONS

The present application claims priority from Chinese application No. 2019108433795 filed on Sep. 6, 2019 which is hereby incorporated by reference in its entirety.

### FIELD OF TECHNOLOGY

The invention relates to the field of concrete equipment, and in particular relates to an automatic processing irrigation truck for concrete pier for bridge pier.

### TECHNICAL FIELD

Concrete trucks are special-purpose trucks used for transporting concrete for construction. Most of them use bucket-shaped mixing buckets to load the concrete. The mixing buckets are rotating in real time, which can prevent the agglomeration of the concrete within a certain period of time. The concrete of the truck device is mostly prepared concrete. If it is transported for a long time, layering will easily occur, which will affect the quality of the concrete, and the mixing effect inside the mixing tank will be poor, so the quality of the concrete will also deteriorate.

### CONTENT OF THE INVENTION

The technical problem to be solved by the present invention is to provide an automatic processing and pouring truck for concrete for bridge piers, which overcomes the problems that the concrete can be transported for a short time and is easy to delaminate during the transportation of concrete.

The present invention is achieved by the following technical solutions.

The invention relates to an automatic processing and pouring vehicle for concrete for bridge piers, which comprises a vehicle body panel. A bottom plate is fixedly arranged on an end surface of the vehicle body plate, and a storage block is fixedly arranged on the right side of the end surface of the bottom plate. There is a processing mechanism, the processing mechanism includes a stirring cavity with an opening facing upward, the mixing cavity is used for mixing mud, the stirring cavity is provided with a rotatable driving shaft, and ten driving shafts are uniformly fixed on the driving shaft. Stirring rods, which can stir the soil when the rotating rods are rotated to prevent the layering of the soil. Four storage chambers are arranged in the storage block with the mixing chamber as the center. There is a rotatable spiral block, and through the rotation of the spiral block, the concrete at the bottom of the mixing chamber can be conveyed to the top, so that the concrete is in a good state; a discharge mechanism is provided on the left side of the storage block, the discharge mechanism includes a support plate fixedly connected to an end surface of the body plate, a front surface of the support plate is rotatably provided with a rotation shaft, and a rotation shaft is fixedly provided on the rotation shaft. A reel and a rotating gear, the reel is located on the front side of the rotating gear, a moving rack meshing with the rotating gear is provided on the lower side of the rotating gear, and a force plate is fixed on the left end wall of the stirring chamber Yes, a rotatable nozzle is provided on the front side of the force plate, and the nozzle is connected to the reel through a rope, and the reel can be driven to be retracted by the meshing of the moving rack with the rotating gear. Tighten the rope, thereby driving the nozzle to rotate, so that the mud in the stirring chamber can be transported to the external space through the nozzle; a hydraulic mechanism is provided on the left side of the top plate, and the hydraulic mechanism is used to push the moving rack.

Preferably, the processing mechanism further includes a working cavity provided in a lower end wall of the stirring cavity, a motor is fixedly located at the center of the lower end surface of the working cavity, and the driving shaft is provided on the upper end surface of the motor in rotation, and the working A driving gear is fixed on the driving shaft in the cavity, a conveying shaft with a lower end rotatably connected to the lower end wall of the working cavity is rotatably provided on the upper end wall of the conveying cavity, and the spiral block is fixed on the conveying shaft. A driving gear is fixed on the conveying shaft in the working chamber, and the driving gear meshes with the driving gear.

Preferably, the hydraulic mechanism includes a cylinder body fixed to the left side of the end surface of the bottom plate, a hydraulic cavity is provided in the cylinder body, a piston is slidably arranged in the hydraulic cavity, and a right end surface of the piston is fixedly disposed. There is a piston rod whose right end is located in the outside space. A connecting plate is fixed at the right end of the piston rod. A guide block and a lateral rack are fixed at the right end of the connecting plate. The lateral rack is located on the upper side of the rear of the guide block. A right side end of the guide block is provided with a guide slot opening to the right, a left end wall of the guide slot is fixedly provided with a pressure spring, and a right end of the pressure spring is fixedly provided with a thrust block slidingly connected to the guide slot; The upper end surface of the cylinder body is provided with a conveying pipe connecting the hydraulic chamber on the left side of the piston and the hydraulic chamber on the right side of the piston, and a hydraulic pump is provided on the conveying pipe.

Preferably, the discharge mechanism further includes a moving groove provided in the bottom plate, the opening of the moving groove is facing upward, a right end wall of the moving slot is fixed with a moving spring, and a left end of the moving spring is fixed with the moving spring. The moving block slidingly connected to the moving groove is provided with a square rod fixed on the upper end surface of the moving block, the mobile rack is fixedly fixed on the right end surface of the square rod, and the square rod is provided with a storage opening opening upward and rearward. A screw shaft is rotatably provided on the lower end wall of the storage cavity, an output gear is fixed on the screw shaft, a lifting block is provided on the upper side of the square rod, and a square with an opening facing downward is provided in the lower end surface of the lifting block Cavity, the square rod is slidably connected to the square cavity, the upper end of the square rod is located in the square cavity, and the upper end wall of the square cavity is provided with a thread groove with an opening facing downward, the thread groove and the thread The shaft is screw-threaded. A top plate is fixed on the upper end surface of the lifting block, and a discharge block is fixed on the right end surface of the top plate. A discharge pipe with an opening rearward is provided in the discharge block, and a left end wall of the discharge pipe is provided with Connect the outer space The connecting pipe is provided with a torsion cavity facing forward in the front end surface of the force receiving plate, and a torsion shaft fixedly connected to the spray head at the front end of the torsion cavity is rotatably connected with the torsion shaft A torsion spring is provided between the cavities, and a hose is provided between the spray head and the leftmost delivery cavity.

Preferably, an end wall of the front side, the rear side, and the right side of the conveying cavity near the driving shaft is provided with an inclined block that communicates with the stirring cavity.

Preferably, the spring force of the compression spring is greater than the spring force of the moving spring.

Preferably, the lateral rack can mesh with the output gear after moving to the right.

Preferably, the torsion spring is in a normal state.

Preferably, the pressure spring is in a normal state.

The beneficial effect of the present invention is that the device can process the concrete for bridge piers during the transportation process, extend the concrete transportation time, and not only can the processing be fully performed, but also can be prevented by means of stirring and spiral circulation of material transportation. Subsequent layering occurs in the mixed soil to ensure the quality of the mixed soil, and when necessary, the mixed soil can be transported out by spiral conveying, and the output is stable.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front structural view of a full cross-section of an automatic processing and pouring truck for concrete of a bridge pier according to the present invention;

FIG. 2 is an enlarged schematic view of A in FIG. 1;

FIG. 3 is a schematic diagram in the direction of B-B in FIG. 1;

FIG. 4 is a schematic diagram of the direction C-C in FIG. 1;

FIG. 5 is a schematic diagram of the D-D direction in FIG. 1.

### DETAILED DESCRIPTION OF THE INVENTION

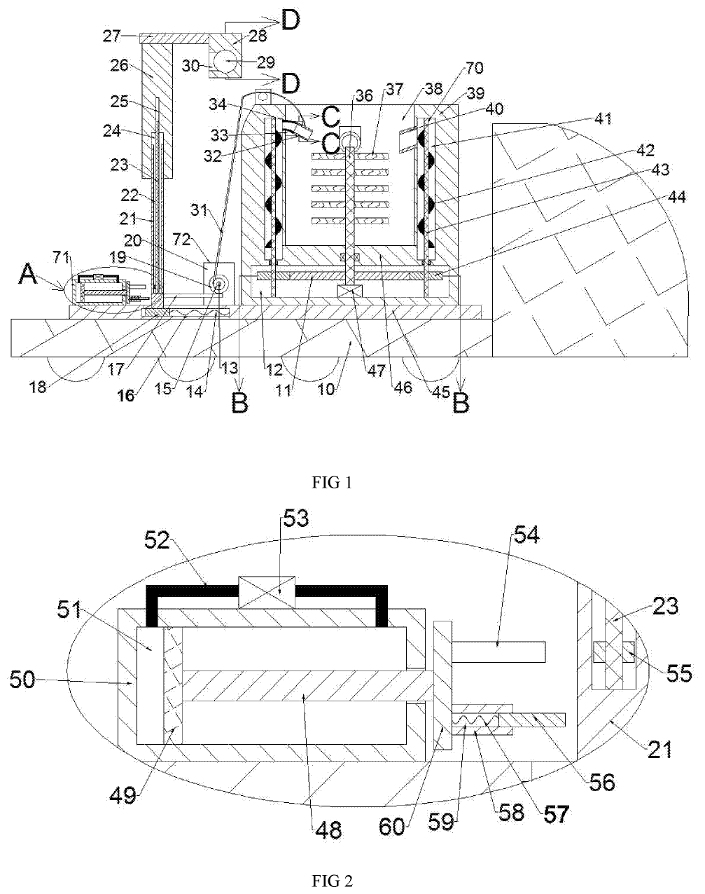

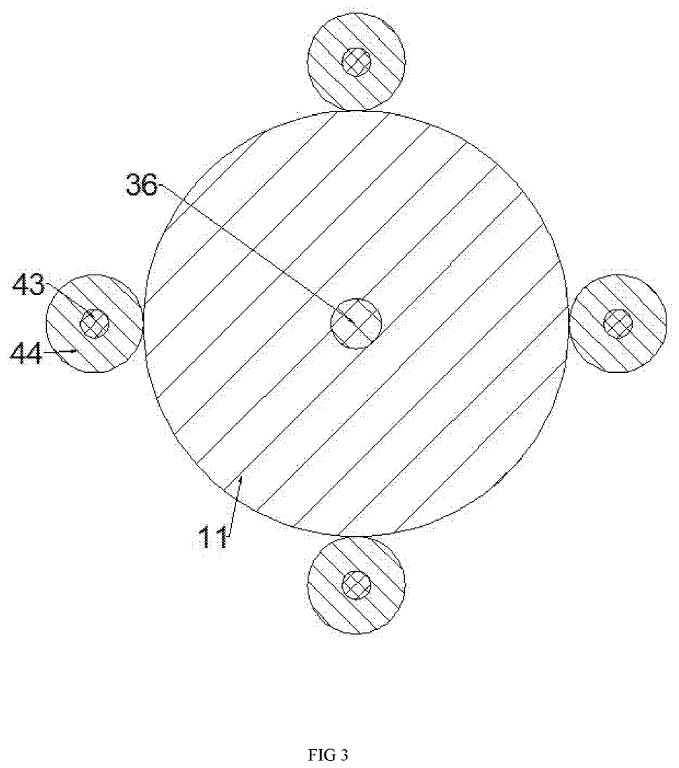

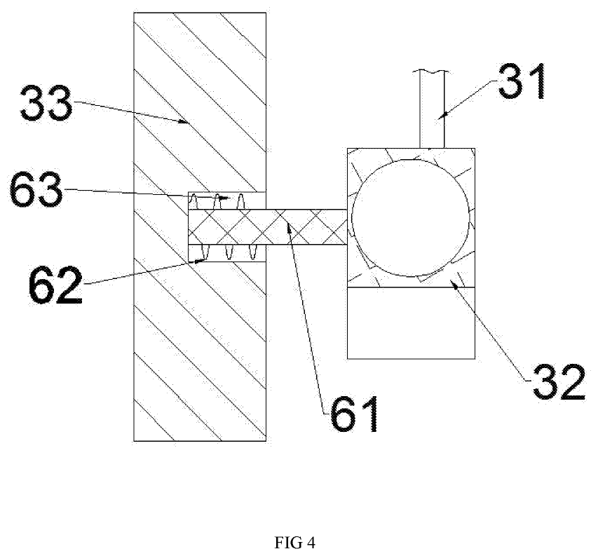

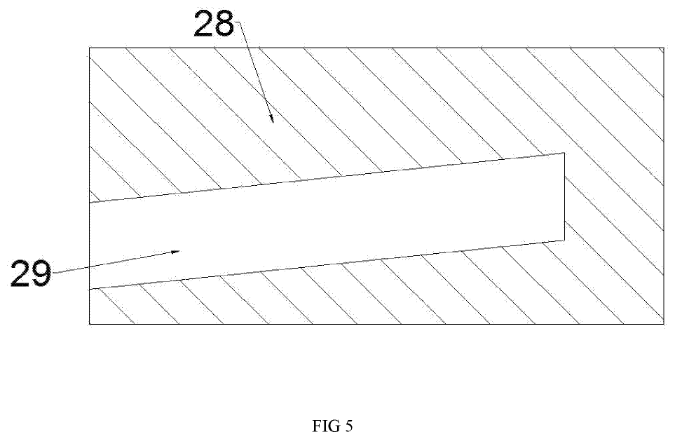

The present invention will be described in detail below with reference to FIG. 1-5. Among them, for convenience of description, the orientation described below is specified as follows: the up-down, left-right, front-back direction described below is consistent with the up-down, left-right, front-back direction of the projection relationship of FIG. 1-5.

A schematic diagram of a mechanical mechanism of a concrete puddle automatic irrigation truck for bridge piers, as shown in FIGS. A storage block 39 is fixed on the right side, and a processing mechanism 70 is provided in the storage block 39. The processing mechanism 70 includes a stirring cavity 38 with an upward opening. The cavity 38 is provided with a rotatable driving shaft 36, and ten driving rods 37 are evenly fixed on the driving shaft 36. When the stirring rod 37 is rotated, the concrete can be stirred to prevent the layering of the concrete. In the storage block 39, four conveying chambers 41 are arranged in an array with the stirring chamber 38 as the center. The conveying chamber 41 is provided with a rotatable spiral block 42. By rotating the spiral block 42, the The bottom concrete in the mixing chamber 38 is conveyed to the top, so that the concrete is in a good condition; a discharge mechanism 72 is provided on the left side of the storage block 39, and the discharge mechanism 72 includes a support plate 20 fixedly connected to the upper end surface of the body panel 10. A front end surface of the support plate 20 is rotatably provided with a rotation shaft 13. A reel 15 and a rotating gear 19 are fixed on the rotating shaft 13. The reel 15 is located on the front side of the rotating gear 19, and a moving tooth meshing with the rotating gear 19 is provided on the lower side of the rotating gear 19. In strip 17, the left end wall of the stirring cavity 38 is fixedly provided with a force receiving plate 33. A rotatable nozzle 32 is provided on the front side of the force receiving plate 33, and the nozzle 32 is connected to the reel 15 through a rope 31. Through the meshing of the moving rack 17 and the rotating gear 19, the reel 15 can be driven to tighten the rope 31, thereby driving the spray head 32 to rotate, so that the mixed soil in the stirring cavity 38 can be Conveyed to the external space through the nozzle 32; a hydraulic mechanism 71 is provided on the left side of the top plate 27, and the hydraulic mechanism 71 is used to push the moving rack 17 to move.

Beneficially, the processing mechanism 70 further includes a working chamber 12 disposed in the lower end wall of the stirring chamber 38. A motor 47 is fixedly located at the center of the lower end surface of the working chamber 12, and the motor 47 is provided with an upper end surface for rotation. A driving shaft 36 is provided with a driving gear 11 fixed on the driving shaft 36 in the working cavity 12, and an upper end wall of the conveying cavity 41 is rotatably provided with a conveying shaft whose lower end is rotatably connected with the lower end wall of the working cavity 12. 43. The spiral block 42 is fixed on the conveying shaft 43. A transmission gear 44 is fixed on the conveying shaft 43 in the working chamber 12, and the transmission gear 44 meshes with the driving gear 11.

Beneficially, the hydraulic mechanism 71 includes a cylinder 50 fixed to the left side of the upper end surface of the bottom plate 45. A hydraulic chamber 51 is provided in the cylinder 50, and a piston 49 is slid in the hydraulic chamber 51. The right end of the piston 49 is fixedly provided with a piston rod 48 whose right end is located in the outside space. The right end of the piston rod 48 is fixed with a connecting plate 60. The right end of the connecting plate 60 is fixed with a guide block 58 and a lateral rack 54. The lateral rack 54 is located at the upper rear side of the guide block 58. A right-side end of the guide block 58 is provided with a guide groove 59 opening to the right. A pressure spring 57 is fixed on the left end wall of the guide groove 59. The right end of the pressure spring 57 is fixed with a thrust block 56 slidably connected to the guide groove 59. The upper end surface of the cylinder 50 is provided with a hydraulic chamber 51 on the left side of the piston 49 and a right side of the piston 49. The conveying pipe 52 of the hydraulic chamber 51 is provided with a hydraulic pump 53.

Advantageously, the discharge mechanism 72 further includes a moving groove 14 provided in the bottom plate 45, the moving groove 14 opening upwards, and a right end wall of the moving groove 14 is fixedly provided with a moving spring 16, the moving spring The left end of 16 is fixedly provided with a moving block 18 slidingly connected to the moving groove 14. A square rod 21 is fixed on the upper end surface of the moving block 18, and the moving rack 17 is fixed on the right end surface of the square rod 21. The square rod 21 is provided with a storage cavity 22 having an opening facing upward and rearward. A lower end wall of the storage cavity 22 is rotatably provided with a threaded shaft 23. An output gear 55 is fixed on the threaded shaft 23. A lifting block 26 is provided on the side, and a square cavity 24 with a downward opening is provided in the lower end surface of the lifting block 26. The square rod 21 is slidably connected to the square cavity 24. The upper end of the square rod 21 is located in the square cavity. In 24, the upper end wall of the square cavity 24 is provided with a thread groove 25 opening downward, the thread groove 25 is screw-connected with the thread shaft 23, and a top plate 27 is fixed on the upper end surface of the lifting block 26. A discharge block 28 is fixed on the right end surface of the top plate 27, and an opening is provided in the discharge block 28 A rear exhaust pipe 29, a left end wall of the exhaust pipe 29 is provided with a connecting pipe 30 that communicates with the external space, a front end face of the force receiving plate 33 is provided with a torsion cavity 63 opening forward, and a rear wall of the torsion cavity 63 A torsion shaft 61 with a front end fixedly connected to the nozzle 32 is rotatably provided. A torsion spring 62 is provided between the torsion shaft 61 and the torsion cavity 63, and a nozzle spring 32 is provided between the nozzle 32 and the conveying cavity 41 on the far left. Hose 34.

Advantageously, an end wall of the front side, the rear side and the right side of the conveying cavity 41 near the driving shaft 36 is provided with an inclined block 40 communicating with the stirring cavity 38.

Advantageously, the elastic force of the pressure spring 57 is greater than the elastic force of the moving spring 16.

Advantageously, the lateral rack 54 can mesh with the output gear 55 after moving to the right.

Beneficially, the torsion spring 62 is in a normal state.

Beneficially, the compression spring 57 is in a normal state.

The sequence of mechanical actions of the entire device:

(1) Add the concrete material with bridge piers into the mixing cavity 38, start the motor 47, and drive the drive shaft 36 to rotate. The stirring rod 37 and the drive gear 11 rotate with the drive shaft 36, and stir all the materials to make concrete.

(2) The meshing of the driving gear 11 and the driving gear 44 drives the driving gear 44 to rotate, and the helical block 42 rotates with the driving gear 44 to convey the bottom concrete in the mixing chamber 38 to the top, making the processing of the concrete faster. The quality is better. After the processing is completed, the stirring of the stirring rod 37 and the conveyance of the spiral block 42 can prevent the stratification of the concrete and ensure the quality.

(3) When concrete is needed, turn off the motor 47, start the hydraulic pump 53, adjust the proportion of hydraulic oil in the hydraulic chamber 51 on the left and right sides of the piston 49, and drive the piston 49 to the right. The connection plate 60 moves to the right with the piston 49. Drive the thrust block 56 and the lateral rack 54 to move to the right. The thrust block 56 pushes the square rod 21 to the right, so that the moving spring 16 is compressed. The meshing of the gear 19 drives the rotation gear 19 to rotate, and the reel 15 rotates the winding rope 31 with the rotation gear 19, thereby pulling the nozzle 32 to rotate.

(4) After the nozzle 32 rotates a certain angle, the square rod 21 cannot continue to move to the right. At this time, the thrust block 56 is pushed into the guide groove 59, the compression spring 57 is compressed, and the lateral rack 54 moves to the right to engage the output gear 55 The output gear 55 is driven to rotate, and the output gear 55 is driven to rotate the screw shaft 23. Through the screw connection of the screw shaft 23 and the screw groove 25, the lifting block 26 is lowered, so that the connection pipe 30 is aligned with the nozzle 32.

(5) Restart the motor 47 to drive the spiral block 42 to rotate. Due to the rotation of the spray head 32 at this time, the leftmost spiral block 42 is rotated to transport the concrete into the connection pipe 30 and to the outside space through the discharge pipe 29.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. An automatic processing irrigation truck for concrete pier for bridge pier, including a body panel, which is characterized by: a bottom plate is fixed on the end surface of the body plate, and a storage block is fixed on the right side of the end surface of the bottom plate. The storage block is provided with a processing mechanism, and the processing mechanism includes a stirring cavity with an upward opening. The mixing chamber is used for containing concrete. The stirring chamber is provided with a rotatable driving shaft. Ten driving rods are evenly fixed on the driving shaft. When the stirring rod is rotated, the concrete can be stirred to prevent The concrete is layered, and four conveying chambers are arranged in the storage block with the stirring chamber as the center. The conveying chamber is provided with a rotatable spiral block. The bottom concrete in the mixing chamber is conveyed to the top, so that the concrete is in a good condition; a discharge mechanism is provided on the left side of the storage block, the discharge mechanism includes a support plate fixedly connected to an end surface of the body plate, a front surface of the support plate is rotatably provided with a rotation shaft, and a rotation shaft is fixedly provided on the rotation shaft. A reel and a rotating gear, the reel is located on the front side of the rotating gear, a moving rack meshing with the rotating gear is provided on the lower side of the rotating gear, and a force plate is fixed on the left end wall of the stirring chamber; a rotatable nozzle is provided on the front side of the force plate, and the nozzle is connected to the reel through a rope, and the reel can be driven to be retracted by the meshing of the moving rack with the rotating gear. Tighten the rope, thereby driving the nozzle to rotate, so that the mud in the stirring chamber can be transported to the external space through the nozzle; a hydraulic mechanism is provided on the left side of the top plate, and the hydraulic mechanism is used to push the moving rack.

2. The automatic processing irrigation truck for concrete pier for bridge pier according to claim 1, characterized in that the processing mechanism further comprises a working cavity arranged in the lower end wall of the stirring cavity, and the center of the lower end face of the working cavity A motor is fixedly provided, the driving shaft is rotatably provided on the upper end surface of the motor, a driving gear is fixed on the driving shaft in the working cavity, and the lower end of the conveying cavity is rotatably provided with a lower end and the driving shaft. A conveying shaft is rotatably connected to the lower end wall of the working cavity, the spiral block is fixed on the conveying shaft, and a driving gear is fixed on the conveying shaft in the working cavity, and the driving gear meshes with the driving gear.

3. The automatic processing irrigation truck for concrete pier for bridge pier according to claim 1, wherein the hydraulic mechanism includes a cylinder body fixed to the left side of the end surface of the bottom plate, and the cylinder body is provided with A hydraulic chamber is provided. A piston is slidably arranged in the hydraulic chamber. A right end of the piston is fixedly provided with a piston rod whose right end is located in the external space. There is a guide block and a transverse rack, the transverse rack is located at the upper rear side of the guide block, a right-side guide groove is provided in the right end surface of the guide block, and a pressure spring is fixed on the left end wall of the guide groove. The right end of the pressure spring is fixedly provided with a thrust block slidingly connected to the guide groove, and the upper end surface of the cylinder body is provided with a conveying pipe connecting the hydraulic chamber on the left side of the piston to the hydraulic chamber on the right side of the piston A hydraulic pump is arranged on the conveying pipe.

4. The automatic processing irrigation truck for concrete pier for bridge pier according to claim 1, wherein the discharging mechanism further comprises a moving groove provided in the bottom plate, and the opening of the moving groove faces upward, so that A moving spring is fixed on the right end wall of the moving groove, and a moving block slidingly connected to the moving groove is fixed on the left end of the moving spring. The moving rack is provided with a storage cavity with openings facing upward and rearward in the square rod, a lower end wall of the storage cavity is provided with a screw shaft, and an output gear is fixed on the screw shaft. A lifting block is provided on the upper side, and a square cavity with a downward opening is provided in the lower end surface of the lifting block. The square rod is slidably connected to the square cavity. The upper end of the square rod is located in the square cavity. The upper end wall of the cavity is provided with a thread groove with an opening facing downward, the thread groove is screw-connected with the thread shaft, a top plate is fixed on the upper end surface of the lifting block, and a discharge block is fixed on the right end surface of the top plate. Descending block A discharge pipe with a rearward opening is provided. A left end wall of the discharge pipe is provided with a connection pipe communicating with the external space. A front end face of the force plate is provided with a torsion cavity with an opening facing forward. A torsion shaft is fixedly connected at the front end to the nozzle, a torsion spring is provided between the torsion shaft and the torsion cavity, and a hose is provided between the nozzle and the conveying cavity at the far left.

5. The automatic processing irrigation truck for concrete pier for bridge pier according to claim 1, characterized in that the front side, the rear side and the right side of the conveying cavity are provided with an end wall close to the drive shaft, and are communicated with each other. An inclined block of the stirring cavity.

6. The automatic processing irrigation truck for concrete pier for bridge pier according to claim 3, wherein the elastic force of the compression spring is greater than the elastic force of the moving spring.

7. The automatic processing irrigation truck for concrete pier for bridge pier according to claim 3, wherein the lateral rack can be engaged with the output gear after moving to the right.

8. The automatic processing irrigation truck for concrete pier for bridge pier according to claim 4, wherein the torsion spring is in a normal state.

9. The automatic processing irrigation truck for concrete pier for bridge pier according to claim 6, wherein the pressure spring is in a normal state.
